(19) United States
(12) Patent Application Publication
(10) Pub. No.: US 2026/0057813 A1
(43) Pub. Date: Feb. 26, 2026

(54) DISPLAY DRIVER CHIP INCLUDING OPTIMAL EQUALIZATION FUNCTION AND OPTIMAL EQUALIZATION METHOD

(71) Applicant: LX SEMICON CO., LTD., Daejeon (KR)

(72) Inventors: Young Bok KIM, Daejeon (KR); Yong Jung KWON, Daejeon (KR); Soo Yeun LEE, Daejeon (KR)

(73) Assignee: LX SEMICON CO., LTD., Daejeon (KR)

(21) Appl. No.: 19/128,329

(22) PCT Filed: Jun. 27, 2023
(86) PCT No.: PCT/KR2023/008885

§ 371 Date: Oct. 13, 2025

(30) Foreign Application Priority Data
Nov. 9, 2022 (KR) 10-2022-0148743

(51) Int. Cl. G09G 3/00; G09G 3/20

(52) U.S. Cl. CPC G09G 3/006; G09G 3/2096; G09G 2310/0275; G09G 2310/0291; G09G 2310/061; G09G 2370/10

(57) ABSTRACT

A display driver chip includes an optimal equalization function and an optimal equalization method, by which image data having high quality may be provided to a display device. The display driver chip may comprise: a data reception unit that receives data; a clock data reconstruction unit that reconstructs an output signal of the data reception unit according to a clock signal; a bit error rate test unit that tests a bit error rate for reconstructed data and provides the result of the test; and an equalization option control unit that configures a condition for initial equalization, configures the number of optimal equalization steps and optional equalization steps to be added, on the basis of the provided test result, and feeds same back to the data reception unit.

### CROSS-REFERENCE TO RELATED APPLICATIONS

This application is a national phase entry of PCT International Application No. PCT/KR2023/008885 filed on Jun. 27, 2023, which claims the priority of Korean Application No. 10-2022-0148743 filed on Nov. 9, 2022, which are hereby incorporated by reference in their entirety.

### BACKGROUND

### Field of the Disclosure

The present disclosure relates to a display driver chip that includes optimal image data equalization functions to provide high-quality image data to display devices, and an optimal equalization method of the display driver chip.

### Description of the Background

As the size of the display screen gradually becomes larger, the number of display driver chips that transmit image data also gradually increases in proportion to the size. In addition, the number of connection wires between driver chips and a timing controller (T-CON) is increasing. The connection wires include data lines, commonly known as bus lines or buses, power lines and ground lines for voltage supply, and control lines for clock signals. The increase in the number of bus lines means that the wires on the printed circuit board or the flexible board on which the driver chip is mounted, becomes more numerous and complex. This not only makes it difficult to design the bezel or mechanism of the display, but also increases manufacturing cost of the display. Furthermore, semiconductor chips require more pins, driving up manufacturing costs. In general, the cost of the semiconductor chips tends to rise with pin count due to higher packaging expenses. Consequently, display panel manufactures consistently urge semiconductor chip makers to reduce pin counts for cost efficiency.

On the other hand, a driver chip of the display, in particular a source driver chip (SDIC), has an “EQ” pin, which is an equalizing pin installed for the purpose of receiving serially image data transmitted from a timing controller 130 at the correct timing, as shown in FIG. 1. This EQ pin allows the source driver chip 110 to optimize the serial data reception. Optimization includes the addition of a bit error rate test (BERT) function to detect data bit errors. This test function is automatically performed by triggering the operation of the equalizer circuit within the source driver chip 110 through the EQ pin, which protrudes externally from the chip.

To further understand the function of the auto-equalization embedded in the source driver chip 110, it will be described with reference to the timing diagram illustrated in FIG. 2. The auto-equalization is executed before the frame-by-frame image data that fills one screen of the display is received. The auto-equalization follows a preset execution operation within the source driver chip 110 that receives the data, referred to as “RX Configuration” in FIG. 2. After the auto-equalization is complete, the source driver chip 110 receives image data for each frame from the timing controller 130. The data for each frame is composed of the first horizontal data (1H Data) to the (n)th horizontal data (nH Data) with vertical blank (V-Blank) intervals inserted between each frame data. Each of the first to the (n)th horizontal data includes a horizontal blank (H-Blank) interval, an interval receiving a control signal CTR, and an interval receiving image data. For reference, in the case that a single completed screen is composed of multiple frames, a vertical blank (V-Blank) refers to a period of time during which, after the completion of horizontal scans for one frame, the scan line moves vertically to initiate the scanning of the next frame; and a horizontal blank (H-Blank) refers to a period of time that exists between the completion of one horizontal scan and the beginning of the next horizontal scan. These terms are derived from the scanning technology used in traditional cathode ray tubes (CRT), such as Braun tubes.

However, the auto-equalization process performed within the source driver chip 110 not only may consume a considerable amount of time, but also may result in increased operating temperatures or fluctuations in the power supply voltage; and therefore, the equalization conditions need to be strengthened to account for these issues. If the equalization conditions are not strengthened, the quality of the data signals sent and received between the timing controller 130 and the source driver chip 110 will deteriorate, ultimately resulting in poor image quality on the display screen.

### SUMMARY

Accordingly, the present disclosure is to provide high-quality image data to a display device by a circuit that automatically optimizes equalization in a display driver chip.

The present disclosure is also to provide a method for automatically optimizing equalization in a display driver chip.

According to one aspect of the present disclosure to address the problems described above, there is provided a display driver chip with an optimal equalization function, which includes: a data receiving part configured to receive data; a clock data recovery part configured to recover the output signal of the data receiving part to match a clock signal; a bit error rate test part configured to test a bit error rate for the recovered data and provides the results of the test; an equalization option control part configured to set conditions for initial equalization, and to set an optimal equalization step and the number of optional equalization steps to be added based on the test results and fed back to the data receiving part.

According to another aspect of the present disclosure to address the problems described above, there is provided an optimal equalization method of a display driver chip, which includes: a step S20 of executing initial equalization; a step S30 of receiving image data by the display driver chip; a step S40 of recovering the received image data to match a clock signal; a step S50 of testing a bit error rate of the recovered image data; and a step S60 of setting an equalization option based on the test results and applying the equalization option to the reception of image data.

According to the present disclosure, high-quality image data may be provided without any errors in the image data that is supplied to the display device.

According to the present disclosure, high-quality error-free images may be provided to a display device without imposing time constraints on the transmission of the image data by appropriately utilizing vertical blank intervals.

### BRIEF DESCRIPTION OF THE DRAWINGS

FIG. 1 is a diagram for illustrating the background of the present disclosure.

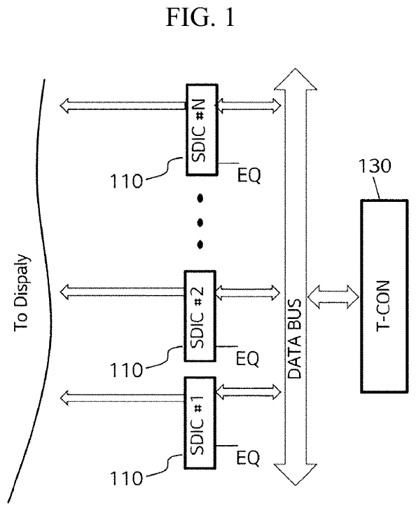

FIG. 2 is a timing diagram for illustrating the background of the present disclosure.

FIG. 3 is a timing diagram according to one aspect of the present disclosure.

FIG. 4 is a block diagram of a circuit according to one aspect of the present disclosure.

FIG. 5 is a flowchart illustrating one aspect of the present disclosure.

### DETAILED DESCRIPTION

Before describing the present disclosure, a brief explanation of the technical terms and abbreviations frequently used in the present disclosure is provided to help understand them. This description makes it possible to more easily understand the technical idea of the present disclosure. First, throughout the specification of the present disclosure, it should be noted that the meanings of the terms chip, integrated circuit (IC), circuit, circuitry, or unit may be used as interchangeable meanings, and may or may not necessarily mean individually packaged configurations, and the meanings of such terms should be interpreted based on the description of the technical content. In addition, “data” herein means “image data”.

A timing controller refers to a semiconductor chip or circuit, also known as a T-CON, which is a configuration that controls the transmission of display data and its timing so that the driving chip or the driving circuitry may properly receive display data. A source driver integrated circuit SDIC refers to a semiconductor integrated circuit (IC) that drives the source direction of a display. In some cases, the source driver chip SDIC may mean an IC in which a readout function that detects and transmits touch signals to a touch IC is incorporated in addition to the source driving function.

Hereinafter, the present disclosure is described for the source driver chip as an example; however, the present disclosure is applicable to any driver chip that transmits image data to a display.

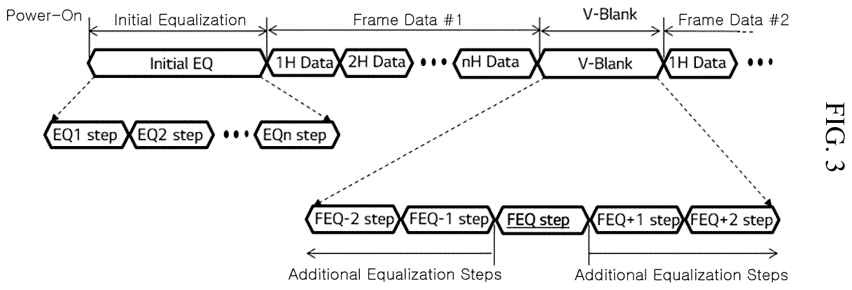

FIG. 3 is a timing diagram presented to better understand the operation of the display driver chip of the present disclosure having an optimal equalization function. The present disclosure addresses the above-described issues by eliminating an external EQ terminal of the source driver chip, and instead integrating a circuit that performs automatic equalization by using a vertical blank interval and its optimal equalization method into a display driver chip, as described in the following aspects. The present disclosure will be described below with reference to FIG. 3. When a source driver chip is initialized by applying a power supply voltage (Power On) or receiving a power-on reset (POR) signal, an initial equalization interval during which an initial equalization (EQ) is automatically performed is set in the non-driving state of the source driver chip.

The initial equalization is a process in which several equalization steps (EQ1 steps to EQn steps) are repeated. During the interval of the initial equalization, the source driver chip performs a scan of all applicable equalization steps, and determines the value of the optimal equalization step by referring to the scan result. For example, if the initial equalization is performed in 20 steps (EQ20 step) and the 10th step (EQ10 step) gives satisfactory equalization results, the optimum equalization step is determined to be the EQ10 step and this value is defined as “FEQ step”. In other words, FEQ step=EQ10 step.

The optimal equalization step (FEQ step) is then used during the vertical blank (V-Blank) interval between frames of data. However, because of the issues described above, it is desirable to include a slight margin in the value of the optimal equalization step (FEQ step) rather than using it directly. For example, one or more additional equalization steps may be added before or after the optimal equalization step (FEQ step).

FIG. 3 illustrates an example where the optimal equalization step is followed by two additional steps before and after, resulting in a total of five steps. The number of additional equalization steps mya be set as an integer multiple of option after the initial equalization step, depending on the designer's needs. For example, when the operating environment of the display driver chip significantly exceeds room temperature, the temperature may have a great effect on the operation of the circuit, so it is desirable to add several additional equalization steps. It is also desirable to add equalization steps even if the power supply voltage of the substrate on which the display driver chip is mounted fluctuates severely.

For reference, while it is obvious to engineers in this field, the vertical blank (V-Blank) interval is not used exclusively for equalization steps. Furthermore, since the vertical blank interval is not infinite in time, it is desirable to ensure that the number of additional equalization steps does not exceed a certain value so that this interval may be properly utilized.

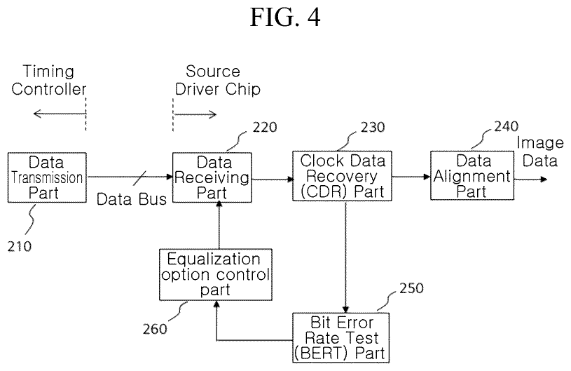

The circuit for performing automatic equalization of the source driver chip's internal circuit, instead of eliminating an external EQ pin on the source driver chip, is illustrated in FIG. 4. The circuit configuration in FIG. 4 indicates the function of each component.

A data transmission part 210 is a circuit configuration belonging to the timing controller (T-CON), which is an end circuit that supplies image data constituted of a series of consecutive frames to the source driver chip.

A data receiving part 220 is a circuit that receives the image data delivered via the data bus from the timing controller. The data receiving part 220 includes an equalization circuit, which may be implemented using an amplifier. The amplifier not only converts distorted image data delivered over a long data bus into a more recognizable digital value, but also performs a proper equalization function in the period when there is no image data.

Periods in which image data is input and other periods in which image data is not input, such as equalization intervals, horizontal blank intervals, or vertical blank intervals, are temporally distinct and are already prescribed between the timing controller 130 and the display driver chip 110 to avoid confusion.

Descriptions of the various equalization functions, such as initial equalization, automatic equalization, optimal equalization, and the number of equalization steps added to these various equalizations, have already been described in the specification of the present disclosure. A continuous time linear equalization (CTLE) amplifier may be used as an internal amplifier.

The continuous time linear equalization (CTLE) amplifier responds continuously and continuously to the input signal, with its response linearly proportional to the gain of the amplifier, and outputs the result as an output.

A clock data recovery (CDR) part 230 is a circuit that recovers data signals so that the output signals from the data receiving part 220 retain their original waveforms or are well synchronized with each clock signals. It should be noted that for ease of description and to better illustrate the core technical ideas of the present disclosure, the clock signal is not depicted separately in the specification of the present disclosure.

A data alignment part 240 is a circuit designed to realign the image data that is properly synchronized with the clock signals and transmit it to the display device. Although not described in detail, the image data sent to the display device may consist of multiple channels and in some cases, may be three channel data representing three primary colors such as Red (R), Green (G) and Blue (B).

For image data that are continuously transmitted from the timing controller in real time, the waveform of the signal may be distorted or damaged as it travels along a long data bus. Even if the data bus is made of a conductive metal material with low resistivity, distortion due to parasitic resistance or parasitic capacitance of the data bus cannot be avoided in the process of transmitting high-frequency image data. Therefore, a function is required in the source driver chip to check that all the image data is transmitted correctly. A bit error rate test (BERT) part 250 is a circuit responsible for this function, which always tests in real time how many bit errors are occurring. The results of the test are provided to an equalization option control part 260.

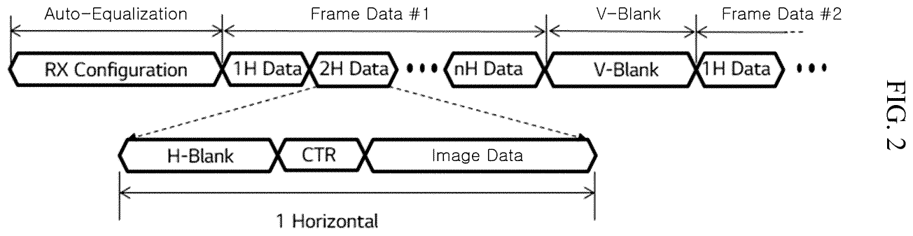

The equalization option control part 260 is a circuit in charge of all the overall control of equalization, including setting various conditions for initial equalization (Initial EQ), determining the optimal equalization steps (FEQ step), and setting the number of equalization steps to be added as an option. Various equalization conditions set or controlled by the equalization option control part 260 are fed back to the data receiving part 220. The data receiving part 220 performs then several equalization operations using equalization circuits. The equalization operations performed by the equalization circuits ensures that the appropriate equalization conditions are combined with each portion of the image data continuously received for each frame, as shown in FIGS. 2 and 3.

As described above, the equalization operations are based on the initial equalization, which is performed immediately after the display driver chip is powered up or immediately after a power-on reset (POR) is executed, the auto-equalization, which is performed before receiving data for each frame, and the optimal equalization, which is performed between frame data intervals. In response to changes in the external environment, such as changes in temperature or fluctuations in power supply voltage, the number of the equalization steps may be variably increased or decreased in addition to the various equalization operations that are set by default. This function may be included in the equalization option control part 260.

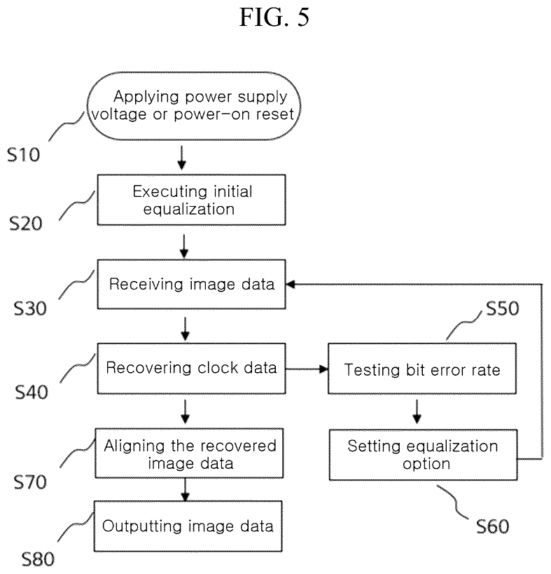

Summarizing the above, as shown in FIG. 5, the optimal equalization method may be summarized as follows. The optimal equalization method starts with a step S10 of applying a power supply voltage or a power-on reset (POR) signal, continues with a step S20 of performing an initial equalization under a preset condition, a step S30 of receiving image data by a display driver chip, a step S40 of recovering the received image data to match a clock signal, a step S50 of testing a bit error rate of the recovered image data, a step S60 of setting an equalization option based on the test result and reflecting it in the reception of image data, and a step S70 of aligning the recovered image data, and ends with a step S80 of outputting and transmitting the aligned image data to the display device. If a significant amount of time has passed since the power-up or power-on reset (POR) signal was applied, the step S10 may be omitted from the optimal equalization method.

According to the present disclosure, which provides a display driver chip equipped with an optimal equalization function and an optimal equalization method, it is feasible to transmit error-free image data even in the presence of environmental changes such as power supply voltage fluctuations, operating temperature variations, and the like, thereby maintaining consistent image quality on the display screen. The present disclosure, although described using the source driver chip as an example, may be applied to any type of display driver chips, and may be implemented regardless of the type of display devices, including LCD or OLED.

1. A display driver chip with an optimal equalization function comprising:
a data receiving part configured to receive data;
a clock data recovery part configured to recover the output signal of the data receiving part to match a clock signal;
a bit error rate test part configured to test a bit error rate of the recovered data and provides the results of the test;
an equalization option control part configured to set conditions for initial equalization, and to set an optimal equalization step and the number of optional equalization steps to be added based on the test results and fed back to the data receiving part.

2. The display driver chip of claim 1, wherein the initial equalization is executed immediately after a power supply voltage is applied, or immediately after a power-on reset signal is applied.

3. The display driver chip of claim 1, wherein the initial equalization is executed before each frame of data is received.

4. The display driver chip of claim 1, wherein the optimal equalization step is executed during the vertical blank interval between frames of data.

5. The display driver chip of claim 1, wherein the data receiving part includes an amplifier configured to perform an equalization operation based on the fed back information.

6. An optimal equalization method of a display driver chip comprising:
a step S20 of executing initial equalization;
a step S30 of receiving image data by the display driver chip;
a step S40 of recovering the received image data to match a clock signal;
a step S50 of testing a bit error rate of the recovered image data; and
a step S60 of setting an equalization option based on the test results and applying the equalization option to the reception of image data.

7. The optimal equalization method of claim 6, further comprising an additional step S10 of applying a power supply voltage or a power-on reset (POR) signal.

8. The optimal equalization method of claim 6, wherein the step S20 of executing the initial equalization is executed under a preset condition in an equalization option control part.

9. The optimal equalization method of claim 6, wherein an optimal equalization step is determined through the step S20 of executing the initial equalization.

10. The optimal equalization method of claim 6, wherein the equalization option control part is configured to determine the number of additional equalization steps to be added as an option.

11. The optimal equalization method of claim 6, wherein the optimal equalization step is used during a vertical blank interval between frames of data constituting the image data.
